(19) United States
(12) Patent Application Publication
(10) Pub. No.: US 2009/0103218 A1
(43) Pub. Date: Apr. 23, 2009

(54) SURGE SUPPRESSION SYSTEM WITH OVERLOAD DISCONNECT

(75) Inventors: Barry Ryan, Dalton Gardens, ID (US); Douglas W. Miller, Rathdrum, ID (US); James Alan Wilson, Coeur d'Alene, ID (US)

Correspondence Address: Stolowitz Ford Cowger LLP, 621 SW Morrison St, Suite 600, Portland, OR, 97205, US

(73) Assignee: A. C. Data Systems of Idaho, Inc., Post Falls, ID (US)

(21) Appl. No.: 11/874,734

(22) Filed: Oct. 18, 2007

(51) Int. Cl. H02H 9/00

(52) U.S. Cl. 361/56

(57) ABSTRACT

A surge suppression unit contains electrical surge suppression components configured to redirect power surges. A sensor monitors the surge suppression components for a possible impending explosion or fire condition. A disconnect mechanism is configured to disconnect power from the surge suppression components when the sensor detects the explosion or fire condition.

### FIELD OF INVENTION

This invention relates generally to surge suppression.

### BACKGROUND

Surge suppression units are used for protecting electrical equipment from electrical power surges. During normal non-power surge conditions, the surge suppression components provide a high resistance path between any combination of power lines, neutral lines, and/or ground lines. During a power surge event, the surge suppressor components start conducting, limiting the voltage across its terminals, which again can be connected to any combination of power lines, neutral lines, and/or ground lines.

During these surge conditions, the surge suppression components that provide the voltage limiting path for the power surge, such as avalanche diodes or varistors, can become hot and can explode and/or electrically arc to other components in the surge suppression unit. These explosions and arcing can damage electrical equipment or possibly cause fires. To reduce explosions and arcing, fuses may be located in series with the diodes or varistors. The fuses are designed to blow at a particular power level and disconnect the associated diode or varistor from the power line experiencing the power surge. These fuses unfortunately have a limited power rating and do not always prevent the diodes and varistors from exploding or catching on fire during a large or extended power surge. For example, the power surge may continue to arc over the blown fuse and eventually cause a fire or explosion.

### BRIEF DESCRIPTION OF THE DRAWINGS

In the accompanying drawings which form a part hereof, and wherein like numbers of reference refer to similar parts throughout:

FIG. 1 is a perspective view of a surge suppression unit.

FIG. 2 is a perspective view of a surge suppression unit with the enclosure top removed.

FIG. 3 is an isolated view of an overload disconnect system used with the surge suppression unit.

FIG. 4 is a top view of a disconnect assembly.

FIG. 5 is a top sectional view of the disconnect assembly in a retracted state.

FIG. 6 is the same top sectional view as FIG. 5 with the disconnect assembly in a triggered state.

FIG. 7 is a side sectional view of the disconnect assembly in the retracted state.

FIG. 8 is the same side sectional view as FIG. 7 with the disconnect assembly in the triggered state.

FIG. 9 is an exploded view of a latch interface used in the disconnect assembly.

FIG. 10 is an alternative embodiment of the overload disconnect system.

FIG. 11 is another embodiment of the overload disconnect system.

FIG. 12 is yet another alternative embodiment of the overload disconnect system.

### DETAILED DESCRIPTION

FIG. 1 shows a surge suppression unit 20 that includes a bottom enclosure section 22B that engages and is covered by a top enclosure section 22A. A first terminal 26 extends from one end of the enclosure 22 and a second terminal 28 extends out the opposite end of enclosure 22. A power line, neutral line, or ground line (not shown) is connected to the first terminal 26 and a power line, ground line or neutral line (not shown) is connected to the second terminal 28. The circuitry contained within enclosure 22 starts conducting when a power surge is detected limiting the voltage across the terminals 26 and 28.

A series of vent holes 23 extend through the end of enclosure 22 and serve as a pressure release vent for some the gasses that may build up in enclosure 22 during an overload condition. The vent holes 23 will be discussed in more detail below.

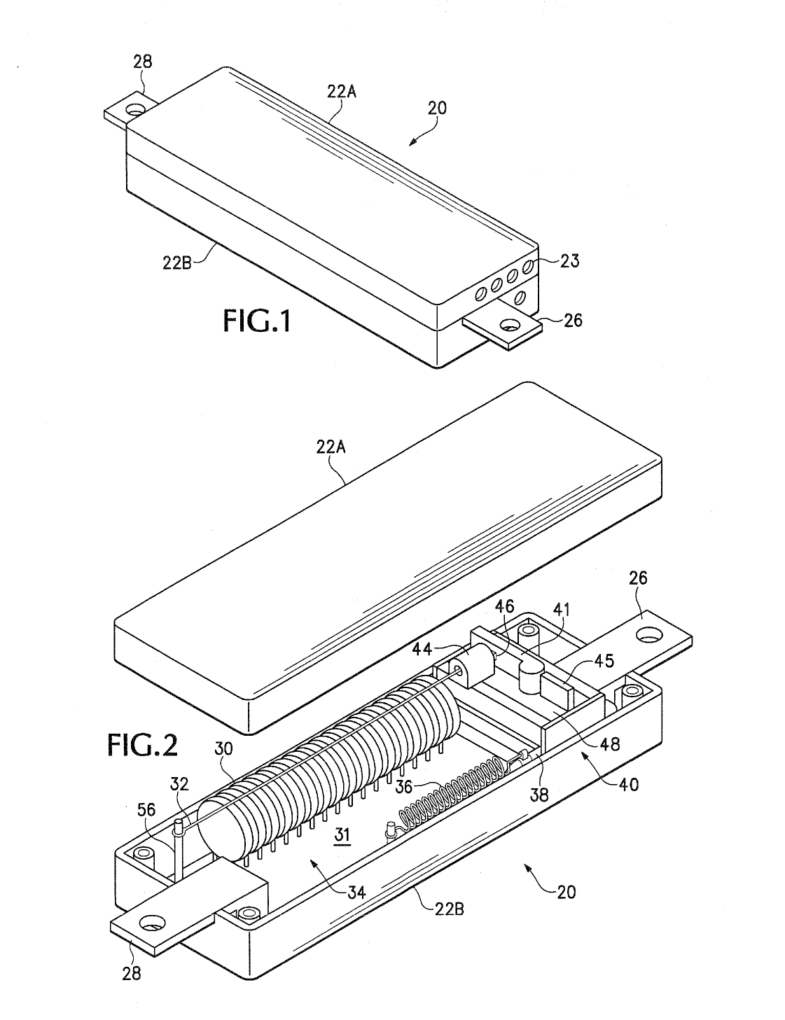

FIG. 2 shows the inside of the surge suppression unit 20. A set of Metal Oxide Varistors (MOVs) 30 are aligned side-by-side on a printed circuit board 31. The MOVs (varistors) 30 provide a high resistance path between the power, neutral, or ground line connected to terminal 26 and the power, neutral, or ground line connected to terminal 28. When a power surge occurs on the line connected to terminal 26, one or more of the varistors 30 start conducting, redirecting the power surge away from electrical equipment (not shown) connected to the line connected to terminal 28.

MOVs 30 are shown in the figures below for explanation purposes. However, it should be understood that the overload disconnect system described below can be used with any type of surge suppression circuitry or surge suppression components including, but not limited to, Silicon Avalanche Diodes (SAD), fuses, thyristors, and any other type of varistor.

It should also be noted that the terms power line, power conductor, or power connector as used in this application can mean any neutral, ground, and/or hot conductor.

As mentioned above, the MOVs 30 limit the voltage across terminals 26 and 28. During the power surge the varistors 30 may heat up enough to either blow up or start burning. The power surge can also create arcing between the conducting varistor 30 and other adjacent varistors 30 or create arcing between the conducting varistor 30 and the other electrical components on circuit board 31. These fires, explosions, and arcing can destroy property located next to surge suppression device 20.

In order to reduce the possibility of property damage, an overload disconnect system is used with the surge suppression unit 20. The overload disconnect system includes a disconnect assembly 40 that severs a conductor connected between terminal 26 and the surge suppression components 30 when one or more of the surge suppression components 30 overheat or catastrophically destruct.

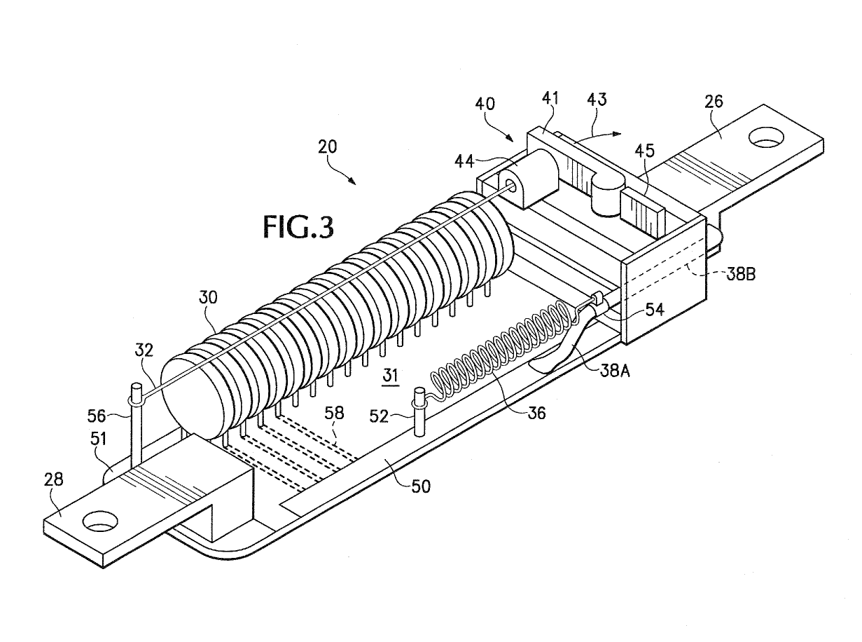

Referring to FIGS. 2 and 3, the terminal 26 is connected to the surge suppression components 30 by a power cable 38. The power cable 38 is attached at one end to the terminal 26 as shown in more detail below. An opposite end 38A of cable 38 is connected to a power bus 50. The power bus 50 is connected to a first terminal of each surge suppression component 30 by individual etched connections 58 printed on a bottom side of printed circuit board 31. A second terminal for each surge suppression component 30 is connected to a second bus 51 that is connected to terminal 28.

A cord 32 is suspended along the surge suppression components 30 between a post 56 and an actuator 44. The cord 32 could be a made of Dacron, fiber, or any other material that would burn apart when the surge suppression components 30 reach a particular temperature that could be the prelude to an explosion or fire condition. In one example, the cord 32 is conventional fishing line. Some materials used for cord 32 may be pre-stretched to prevent a slow disconnect where the cord 32 would first slowly stretch for some period of time before then burning apart.

The actuator 44 is located next to a lever 41 that can swing open in a clockwise direction 43 when viewed from the top. The lever 41 operates a trigger mechanism in disconnect assembly 40. A spring 36 is attached at a first end to a post 52 and attached by a crimped sleeve 54 or soldered to the second end 38A of power cable 38. The spring 36 is attached to power cable 38 in an expanded state that exerts a constant retractive bias force on cable 38. In one embodiment, a single post could be used instead of using two posts 56 and 52.

The cord 32 operates as a sensor for monitoring the amount of heat generated by the surge suppression components 30. When the surge suppression components 30 overheat, the cord 32 burns apart and releases a spring 60 (FIG. 4) in actuator 44. The spring 60 pushes lever 41 open and in turn releases or triggers a spring activated cutter piston inside of disconnect assembly 40.

Any gas pressure from the overheated MOV 30 will tend to move out through the venting holes 23 in FIG. 1 and can help move lever 41 into the open position. Even if the cord 32 does not burn apart, enough gas pressure from one or more overheated MOVs 30 may still move the lever 41 into the open position. The wall 45 further directs any gas pressure across lever 41.

The released cutter piston severs section 38B of the power cable disconnecting terminal 26 from the surge suppression components 30. The spring 36 further retracts back into a non-expanded (non-biased) position pulling the end 38A further apart from the other severed portion 38B of power cable 38.

This physical severing of the power cable 38 and further separation of the severed power cable more effectively disconnects the power surge on terminal 26 from the surge suppression components 30. This physical severing and separation of the power cable 38 reduces arcing that could continue if a conventional fuse were used between terminal 26 and the surge suppression components 30. As a result, the surge suppression unit 20 has less chance of exploding or starting a fire.

A power surge could cause one or more of the MOVs 30 to start continuously conducting (shorting condition). If the power surge continues to pass through the conducting MOV 30 for an extended period of time, the MOV could then explode. These long drawn out over current conditions may not necessarily trigger individual fuses connected to each MOV.

The disconnect system prevents the surge suppression unit 20 from exploding by melting the cord 32 and disconnecting power before the surge suppression unit 20 reaches an explosive level. Extended over voltage or over current conditions still burn apart the cord 32 and disconnect power when the MOVs 30 become hotter than normal beyond some extended period of time. The overload disconnect system in some instances may replace multiple individual fuses that are used with each MOV 30. Thus, the surge suppression unit 20 may also be less expensive to manufacture in certain applications.

A barrier wall 45 is located at the pivoting end of lever 41. The wall 45 provides a barrier that prevents gas from passing around level 41. When top cover 22A is installed, the wall 45 extends up to the bottom surface of the top cover 22A. The wall 45 directs gas from any overheating of MOVs 30 toward lever 41 further pushing the lever 41 backwards and triggering disconnect assembly 40. This will be explained in more detail below in FIG. 12.

FIGS. 4-9 explain the operation of the disconnect assembly 40 in more detail. Referring first to FIG. 4, the actuator 44 includes spring 60. A stop washer 46 is positioned in-front of spring 60 and attached to cord 32. The cord 32 pulls back on stop washer 46 pulling spring 60 back into a retracted compressed state. When cord 32 burns apart as shown in FIG. 4, the broken cord 32 releases stop washer 46 allowing spring 60 to extend forward. The released spring 60 pushes stop washer 46 further forward pushing the lever 41 into position 42B.

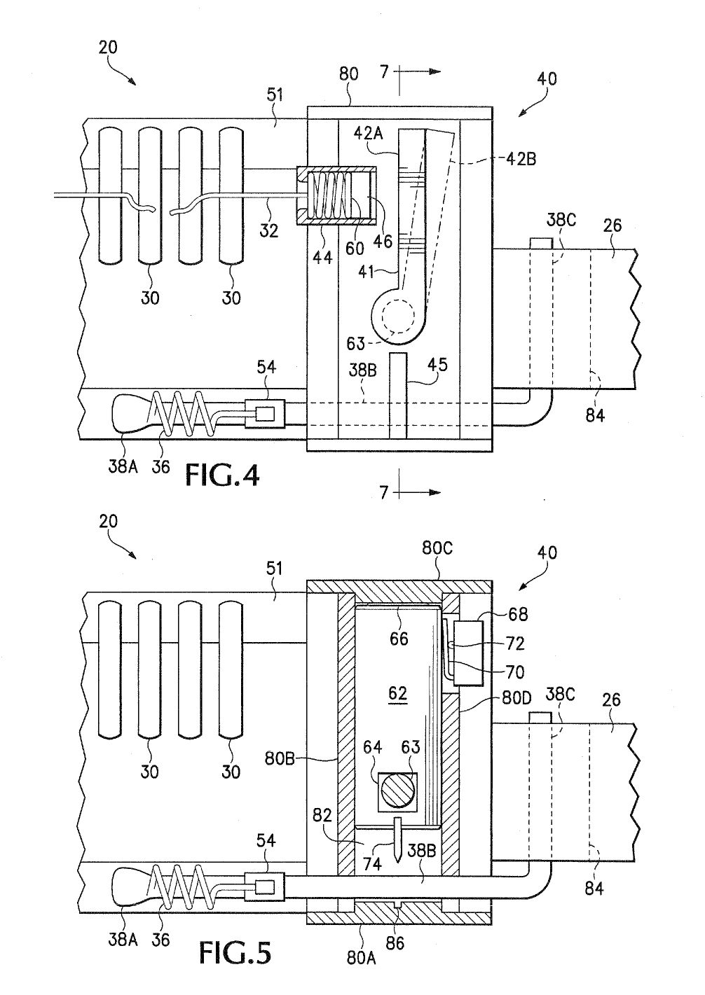

Referring now to FIG. 5, cable end 38C is electrically coupled to a lug 84 formed on the bottom of terminal 26. The middle portion 38B of the power cable is suspended within a chamber 82 formed by walls 80.

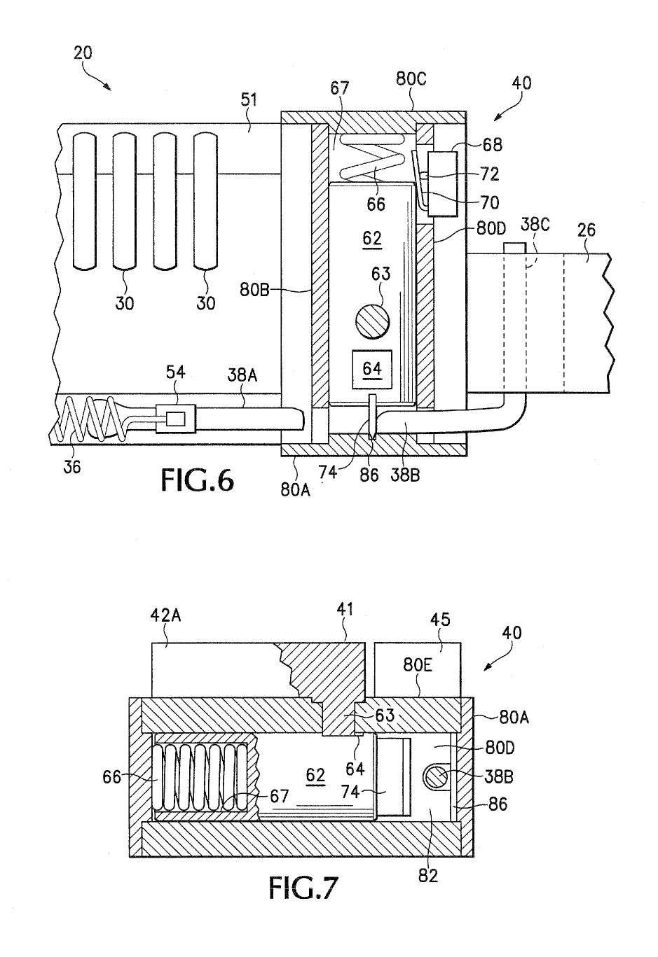

A piston 62 includes a slot 64 that receives a rod 63 that extends down from lever 41. A first end of piston 62 includes a cavity 67 that retains a spring 66 (see FIGS. 6 and 7). An opposite end of piston 62 retains a cutter/knife 74. In the retracted/locked position shown in FIG. 5, the piston 62 is pushed back against the back wall 80C compressing the spring 66 within cavity 67. The lever 41 is moved into position 42A shown in FIG. 4 causing rod 63 to insert down into slot 64 and lock the piston 62 into the retracted position shown in FIGS. 5 and 7.

An annunciation sensor 68 is located in an opening in side wall 80D and includes a first contact 70 that is depressed against a button 72 when piston 62 is in the retracted position shown in FIG. 5.

Moving now to FIG. 6, the lever 41 is moved into position 42B in FIG. 4. As described above, this happens when the cord 32 burns apart due to excessive heat coming from one or more of the surge suppression components 30. The broken cord 32 releases spring 60 in actuator 44 allowing washer 46 to push the lever 41 into position 42B.

Moving lever 41 into position 42B causes the lever rod 63 to move up and out of the slot 64 formed in piston 62. This allows the spring 66 to extend out into a non-compressed/non-biased state while moving piston 62 out toward front wall 80A. The spring 66 causes cutter 74 to slice thru and sever the suspended cable section 38B and lodge into a notch 86 formed in front wall 80A.

As soon as the cutter 74 severs power cable 38, the outstretched spring 36 is allowed to move back into an unbiased position pulling power cable end 38A back and away from cable section 38B. Any power from a power line connected to terminal 26 is then disconnected from the surge suppression components 30. Thus, any overload conditions that could cause surge suppression unit 20 to explode or catch on fire are quashed.

Physical features of the disconnect assembly 40 help prevent arcing between power cable section 38B and other components in surge suppression unit 20. The cutter 74 could be made from a non-metallic material, such as a ceramic. In this case, the cutter 74 forms a physical barrier between cable section 38B and cable end 38A. This blocks arcing that could extend between the two severed parts of power cable 38. Of course, the cutter 74 could also me made out of a metallic material, such as steel or any other material that can sever cable section 38B. Secondly, the spring 36 pulls the cable end 38A further away from severed cable section 38B making arcing less likely over the wider separation distance. Further, the severed cable section 38B connected to the hot power line is contained within walls 80 that provide an additional barrier in front of bus 51 and the electrical components in surge suppression unit 20.

In the extended position shown in FIG. 6, the piston 62 moves forward and away from sensor 68. This allows contact 70 to move outward releasing button 72. Released button 72 activates a switch that can then be used to activate an annunciator or visual indicator that provides notification that an overload condition has been detected and the surge suppression unit 20 is now disabled.

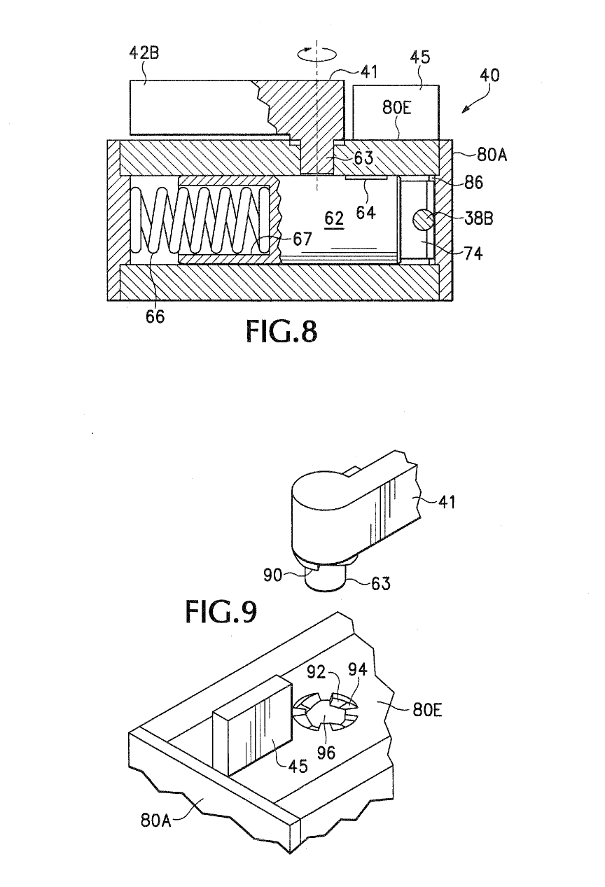

FIGS. 7 and 8 are side cut-away views that further show how the disconnect assembly 40 operates. In the retracted position shown in FIG. 7, the spring 66 is compressed almost entirely within cavity 67. The lever 41 is in position 42A such that rod 63 extends down into slot 64 of piston 62. The power cable portion 38B is shown suspended by side wall 80D within chamber 82.

FIG. 8 shows the released position of the disconnect assembly 40. The lever 41 is moved by actuator 44 in FIG. 4 into position 42B. While moving from position 42A to position 42B, a ramped interface between a bottom side of lever 41 and a top surface on wall 80E forces the rod 63 upward out of slot 64. This releases piston 62 allowing the spring 66 to release outward forcing cutter 74 through power cable portion 38B and into the slot 86 in wall 80A.

FIG. 9 shows the ramped interface in more detail. The top wall 80E has a hole 96 that receives rod 63. Multiple lower platform areas 92 are formed around the outside of hole 96. Each platform area 92 then transitions to a ramped area 94 that inclines upward toward a top surface of upper wall 80E. A collar 90 surrounds the top end of rod 63 that has downwardly inclining ramps that sit into the platform areas 92 and inclined ramp areas 94 formed around hole 96. When the lever 41 is in position 42A, the collar 90 sits down into the platform areas 92 and 96 such that rod 63 extends down into slot 64. When the lever 41 is moved to position 42B, the two oppositely inclining ramps formed by collar 90 and area 94 lift the rod 63 slightly upward out of slot 64. It should be noted that any number of ramps or alternative threaded arrangements could be used to move the lever 41 upward out of slot 64, and the embodiment shown in FIG. 9 is just one example.

The motion of lever 41 in relation to areas 92 and 94 is analogous to the movement of a threaded screw being removed from a nut when the nut is held stationary. The twisting of the ramped collar 90 against the ramp formed by inclined area 94 moves the rod 64 upward, thereby releasing the piston 62 and cutter 74.

### ALTERNATIVE EMBODIMENTS

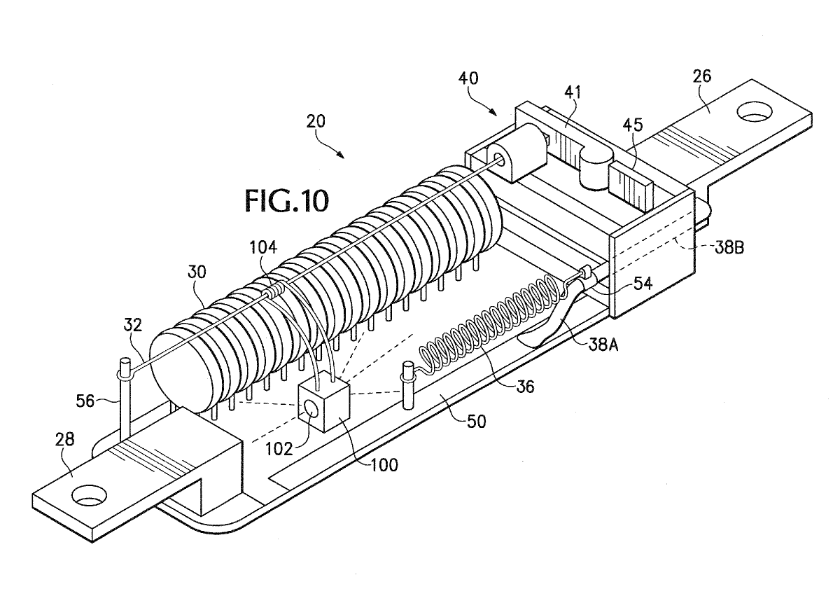

FIG. 10 shows another embodiment were an infrared controller 100 includes infrared sensors 102 that detect the emission of infrared waves from the surge suppression components 30. When the infrared waves detected by sensors 102 indicate a particular heat level, the controller 100 connects power from power bus 50 to a wire coil 104 that is wrapped around cord 32. The coil 104 acts like a heater burning apart the cord 32 and activating the disconnect assembly 40 in a manner similar to that described above.

In this arrangement, either the heat from the surge suppression units 30 can directly burn apart the cord 32 or the heat from coil 104 can burn apart the cord 32. Thus, the infrared sensors 102 provide a second level of overload detection.

In yet another embodiment, the controller 100 may include one or more pressure sensors. The pressure sensors in controller 110 detect a pressure change inside of the enclosure 22 and then activate the coil 104 to break cord 32 and trigger disconnect assembly 40. In this embodiment, there may be no or fewer pressure release holes 23 (FIG. 1) so that built up pressure inside of enclosure 22 is more accurately detected.

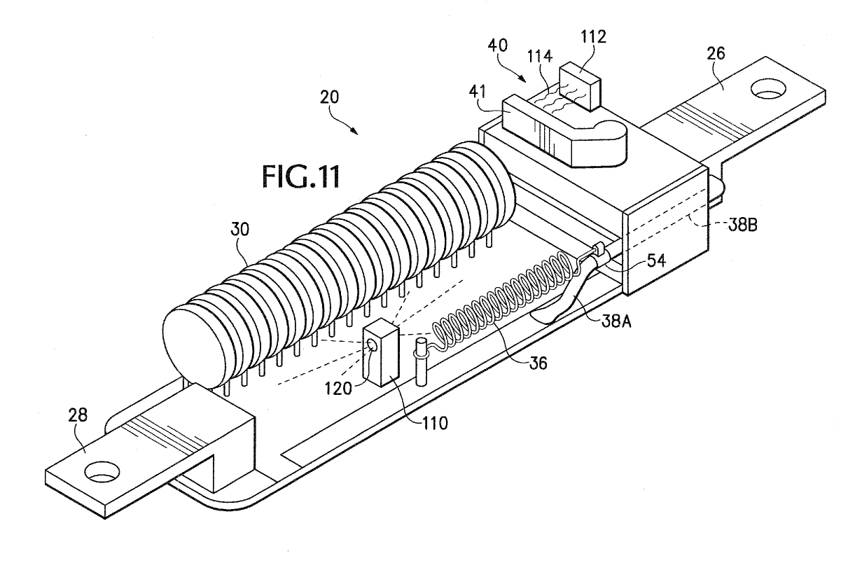

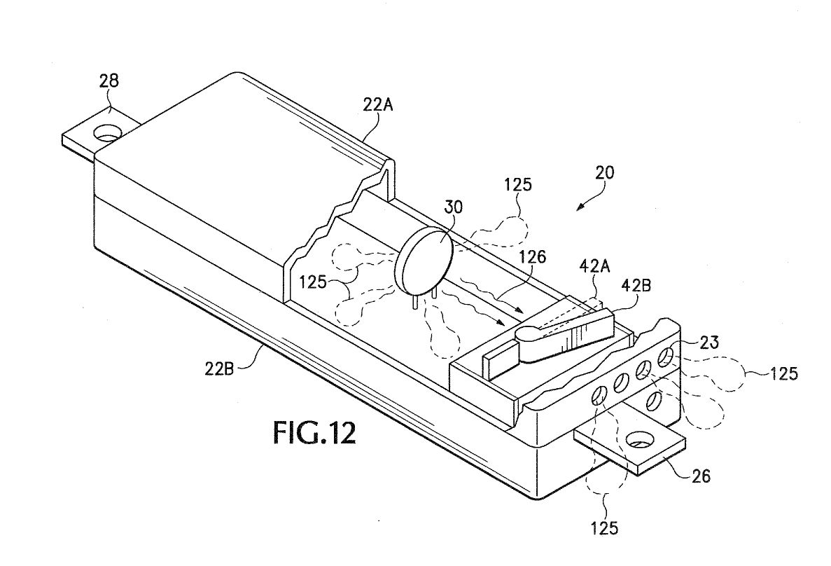

FIG. 11 shows another embodiment where a controller 110 includes pressure, motion, and/or heat sensors 120 that detect an overload condition in surge suppression unit 20. Instead of burning apart a cord, the controller 110 activates an electromagnet 112 that then pulls lever 41 into position 42B triggering the disconnect assembly 40. In this embodiment, the lever 41 may have a metal plate attached to a back side to interact with electromagnet 112. Alternatively, an electromagnetic solenoid type switch may be used for triggering the disconnect assembly 40.

Referring FIG. 12, vents holes 23 extend through the end of enclosure 22. Gas pressure 125 is created inside of enclosure 22 when electronic components in the surge suppression unit 20 overheat or rupture. Some of the gas pressure 125 will move to a lower pressure environment outside of enclosure 22 through vent holes 23. The movement 126 of gas 125 from inside of enclosure 22 to outside of enclosure 22 can swing lever 41 from position 42A to release position 42B activating disconnect assembly 40. In this embodiment, the length and/or height of lever 41 may be increased to provide a larger surface area in front of vent holes 23. This allows more of the pressure from gas 125 to push against the larger surface area of lever 41 and provide more force for moving lever 41 into position 42B.

Any combination of the cord 32 in FIGS. 2 and 3; infrared, pressure, or heat sensors 102 and heating coil 104 in FIG. 10; and/or pressure, motion, or heat sensors in FIGS. 11 and 12 can be used to detect an overload condition and disconnect power from the surge suppression unit 20.

Having described and illustrated the principles of the invention in a preferred embodiment thereof, it should be apparent that the invention can be modified in arrangement and detail without departing from such principles. We claim all modifications and variation coming within the spirit and scope of the following claims.

1. A surge suppression unit, comprising:
electrical surge suppression components configured to redirect power surges; and
a disconnect assembly configured to sever a conductor to the surge suppression components when one or more of the surge suppression components overheat or destruct.

2. The surge suppression unit according to claim 1 wherein the disconnect assembly includes a cutter that cuts the conductor.

3. The surge suppression unit according to claim 2 including a spring activated piston connected to the cutter, the piston maintained in a locked condition and when unlocked allowing the spring to move the cutter to slice through the conductor.

4. The surge suppression unit according to claim 1 including a sensor monitoring the surge suppression components and activating the disconnect assembly.

5. The surge suppression unit according to claim 4 wherein the sensor comprises a cord extended along the surge suppression components that burns apart when one or more of the surge suppression components overheat or destruct.

6. The surge suppression unit according to claim 5 including a spring held in a retracted condition by the cord that then releases and activates the disconnect assembly when the cord burns apart.

7. The surge suppression unit according to claim 5 wherein the cord is a made of Dacron, fiber, or other material that will break apart when heated to a predetermined temperature.

8. The surge suppression unit according to claim 5 including a wire attached to the cord configured to burn apart the cord when a second sensor detects one or more of the surge suppression components overheating or destructing.

9. The surge suppression unit according to claim 4 wherein the sensor comprises an infrared sensor, pressure sensor, or motion sensor.

10. The surge suppression unit according to claim 4 including an electromagnetic solenoid activating the disconnect assembly according to a signal received by the sensor.

11. The surge suppression unit according to claim 1 including a spring that pulls apart the conductor after being severed by the disconnect assembly.

12. The surge suppression unit according to claim 1 including:
a piston configured to hold a knife in a spring loaded position; and
an actuator configured to move a lever that releases the piston from the spring loaded position causing the knife to sever the conductor.

13. The surge suppression unit according to claim 12 wherein the actuator comprises a spring that moves into an extended position that moves the lever.

14. The surge suppression unit according to claim 1 including:
an enclosure having pressure vents for releasing gas pressure created by overheated or destructed electrical components in the surge suppression unit; and
a pressure sensor triggered by the gas pressure releasing through the pressure vents to activate the disconnect assembly.

15. The surge suppression unit according to claim 14 wherein the pressure sensor comprises a lever that the gas pressure moves from a first position to a second position.

16. A method, comprising:
monitoring a temperature or pressure from one or more surge suppression components; and
disconnecting a conductor to the surge suppression components when the monitored temperature or pressure from the surge suppression components indicate an overload condition.

17. The method according to claim 16 further comprising disconnecting the conductor by cutting apart a wire that couples a terminal to the surge suppression components.

18. The method according to claim 17 further comprising pulling the cut wire further apart.

19. The method according to claim 16 further comprising moving a lever to initiate the disconnection of the conductor.

20. The method according to claim 19 further comprising releasing a compressed spring that moves the lever.

21. The method according to claim 16 further comprising:
suspending a cord next to the one or more of surge suppression components; and
detecting the overload condition when one or more surge suppression components get hot enough to break apart the cord.

22. The method according to claim 21 further comprising:
triggering a disconnect mechanism to cut apart the conductor when the cord breaks apart.

23. The method according to claim 16 further comprising using gas pressure released from the surge suppression components to activate a disconnect mechanism that disconnects the conductor.

24. The method according to claim 16 further comprising:
monitoring infrared waves coming from the surge suppression components; and
disconnecting the conductor according to the monitored infrared waves.

25. A surge suppression device, comprising:
a conductor coupling power to surge suppression components;
a disconnect mechanism; and
a trigger unlocking the disconnect mechanism when an overload condition is detected causing the disconnect mechanism to disconnect power to the surge suppression components.

26. The surge suppression device according to claim 25 including:
an actuator located next to the trigger mechanism; and
a cord suspended next to the surge suppression components holding the actuator in a compressed state, the cord burning apart when the surge suppression components overheat releasing the actuator and causing the actuator to move the trigger and unlock the disconnect mechanism.

27. The surge suppression device according to claim 25 further comprising an enclosure having pressure vents located adjacent to the trigger so that gas pressure created inside of the enclosure escapes out through the pressure vents while at the same time moving the trigger and unlocking the disconnect mechanism.

28. The surge suppression device according to claim 25 further comprising a pressure, temperature, or infrared sensor that initiates movement of the trigger for unlocking the disconnect mechanism.

29. The surge suppression device according to claim 28 further comprising an electromagnetic solenoid that when activated by the sensor moves the trigger and unlocks the disconnect mechanism.

30. The surge suppression device according to claim 25 further comprising an annunciation sensor that activates an annunciation device when the disconnect mechanism is unlocked.

31. The surge suppression device according to claim 25 further comprising:
a knife located in the disconnect mechanism that severs a wire connecting power to the surge suppression components; and
a spring that pulls a first end of the severed wire apart from a second end of the severed wire.
